(19) United States
(12) Patent Application Publication
(10) Pub. No.: US 2024/0428574 A1
(43) Pub. Date: Dec. 26, 2024

(54) APPARATUS AND METHOD FOR GENERATING DATA FOR TRANING OF NEURAL NETWORK AND STORAGE MEDIUM STORING INSTRUCTIONS TO PERFORM METHOD FOR GENERATING DATA FOR TRANING OF NEURAL NETWORK

(71) Applicant: Research & Business Foundation SUNGKYUNKWAN UNIVERSITY, Suwon-si (KR)

(72) Inventors: Jae Wook JEON, Suwon-si (KR); Duong Nguyen Ngoc TRAN, Suwon-si (KR); Hyung-Min JEON, Suwon-si (KR); Long Hoang PHAM, Suwon-si (KR); Huy-Hung NGUYEN, Suwon-si (KR)

(73) Assignee: Research & Business Foundation SUNGKYUNKWAN UNIVERSITY, Suwon-si (KR)

(21) Appl. No.: 18/413,222

(22) Filed: Jan. 16, 2024

(30) Foreign Application Priority Data
Jan. 16, 2023 (KR) 10-2023-0006155

(51) Int. Cl. G06V 10/82; G06V 10/77; G06V 20/58

(52) U.S. Cl. CPC G06V 10/82; G06V 10/7715; G06V 20/58

(57) ABSTRACT

There is provided an apparatus for generating a training data. The apparatus comprises a memory storing instructions; and a processor executing the instructions, wherein the instructions, when executed by the processor, cause the processor to: prepare 3D graphic road environment data required for rendering of 3D graphic road environment including a road and at least one object moving on the road, and set a photographing environment of a camera capturing the road and the at least one object moving on the road within the rendered 3D graphic road environment, generate a virtual captured image obtained by capturing the road and the at least one object moving on the road in the 3D graphic road environment based on information on the photographing environment of the camera, and extract training ground truth data from the virtual captured image to generate the training data including the virtual captured image and the training ground truth data.

### TECHNICAL FIELD

The present disclosure relates to a data generation apparatus and method, and more specifically, to an apparatus and method for generating data to be used for training of a neural network.

This work was supported by Institute of Information & communications Technology Planning & Evaluation (IITP) grant funded by Korea government (MSIT; Ministry of Science and ICT) ((SW Star Lab) Development of Continuous Real-Time Intelligent Traffic Monitoring System on Edge Devices (No. S-2021-2779)).

### BACKGROUND

With the increase of an urban population, traffic jams and environmental pollution caused by vehicles are becoming more serious, and the number of accidents is also increasing. However, in future smart cities, these problems are expected to be alleviated through various sensors installed near intersections and a computer vision-based intelligent traffic control system.

The development of the intelligent traffic control system requires data of vehicles and pedestrians for training of a neural network, but it is difficult to collect training data without permission from each local government due to a privacy protection policy. Further, even when there is the permission from the local government, a process of collecting actual photographs and setting ground truth (GT) to generate a training dataset for the Neural network requires enormous manpower and costs. In addition, because it is difficult to recognize objects in environments such as night and rainy weather, there is a problem that data sets for the night and rainy environments are insufficient, and GT information thereof is also inaccurate.

### SUMMARY

An object of the present disclosure is to provide an apparatus and method capable of generating data for training of a neural network free from regulations regarding personal information.

Another object of the present disclosure is to provide an apparatus and method that allow anyone to easily generate data for training of a neural network at a low cost.

Yet another object of the present disclosure is to provide an apparatus and method capable of generating high-precision GT data.

The aspects of the present disclosure are not limited to the foregoing, and other aspects not mentioned herein will be clearly understood by those skilled in the art from the following description.

In accordance with an aspect of the present disclosure, there is provided an apparatus for generating data for training of a neural network, the apparatus comprises: a memory configured to store one or more instructions; and a processor configured to execute the one or more instructions stored in the memory, wherein the instructions, when executed by the processor, cause the processor to: prepare 3D graphic road environment data required for rendering of 3D graphic road environment including a road and at least one object moving on the road, and set a photographing environment of a camera configured to capture the road and the at least one object moving on the road within the rendered 3D graphic road environment, generate a virtual captured image obtained by capturing the road and the at least one object moving on the road in the 3D graphic road environment based on information on the photographing environment of the camera, and extract training ground truth (GT) data from the virtual captured image to generate the data for training of the Neural network including the virtual captured image and the training GT data.

Wherein the processor may be configured to set a time condition and a weather condition corresponding to daytime or nighttime in the 3D graphic road environment.

Additionally, the photographing environment may include an installation position, height, and rotation angle of the camera within the 3D graphic road environment.

The apparatus may further comprise an object detector installed to the inside or outside of the camera and configured to acquire information on the at least one object.

Additionally, the processor may be configured to extract a unique color value and contour information from the at least one object using the object detector.

Additionally, the training GT data includes bounding box information indicating an area in which there is the at least one object and mask information indicating an identifier for identifying the at least one object.

Additionally, the photographing environment of the camera may include a photographing environment for each of cameras installed at a plurality of positions, and the processor may be configured to generate a plurality of virtual captured images based on information on the photographing environment of each of the cameras installed at the plurality of positions, and assign a unique identifier for the at least one object and tracks a position of the at least one object detected from the plurality of virtual captured images based on the unique identifier to generate the training GT data.

In accordance with another aspect of the present disclosure, there is provided a training data generation method to be performed by an apparatus for generating training data, the training data generation method comprises: preparing 3D graphic road environment data required for rendering of 3D graphic road environment including a road and at least one object moving on the road: setting a photographing environment of a camera configured to capture the road and the at least one object moving on the road within the rendered 3D graphic road environment: generating a virtual captured image obtained by capturing the road and the at least one object moving on the road in the 3D graphic road environment based on information on the photographing environment of the camera: extracting training ground truth (GT) data from the virtual captured image; and generating the training data including the virtual captured image and the training GT data.

In accordance with another aspect of the present disclosure, there is provided computer program including computer executable instructions stored in a non-transitory computer readable storage medium, wherein the instructions, when executed by a processor, cause the processor to perform a training data generation method, the method comprises: preparing 3D graphic road environment data required for rendering of 3D graphic road environment including a road and at least one object moving on the road: setting a photographing environment of a camera configured to capture the road and the at least one object moving on the road within the rendered 3D graphic road environment: generating a virtual captured image obtained by capturing the road and the at least one object moving on the road in the 3D graphic road environment based on information on the photographing environment of the camera: extracting training ground truth (GT) data from the virtual captured image; and generating the training data including the virtual captured image and the training GT data.

In accordance with another aspect of the present disclosure, there is provided a non-transitory computer readable storage medium storing computer executable instructions, wherein the instructions, when executed by a processor, cause the processor to perform a training data generation method, the method comprises: preparing 3D graphic road environment data required for rendering of 3D graphic road environment including a road and at least one object moving on the road: setting a photographing environment of a camera configured to capture the road and the at least one object moving on the road within the rendered 3D graphic road environment: generating a virtual captured image obtained by capturing the road and the at least one object moving on the road in the 3D graphic road environment based on information on the photographing environment of the camera: extracting training ground truth (GT) data from the virtual captured image; and generating the training data including the virtual captured image and the training GT data.

According to an embodiment of the present disclosure, since a dataset is generated on the basis of a virtual map, there are no restrictions when data that must be used in compliance with regulations or that is sensitive is used.

According to an embodiment of the present disclosure, it is possible for anyone to easily generate data for training of a neural network at a low cost, and to satisfy conditions that cannot be satisfied by actual measurement data.

According to an embodiment of the present disclosure, since GT data for a neural network is generated together with training data for the Neural network, it is possible to generate a large number of training datasets along with high-precision GT data without a human labeling task, and to greatly reduce a data generation cost.

### BRIEF DESCRIPTION OF THE DRAWINGS

FIG. 1 is a diagram illustrating a data generation device according to an embodiment of the present disclosure.

FIGS. 2 and 3 are diagrams illustrating a process in which the data generation device sets an environment for training of a neural network according to an embodiment of the present disclosure.

FIG. 4 is a diagram illustrating image data according to an embodiment of the present disclosure.

FIG. 5 is a diagram illustrating GT data according to an embodiment of the present disclosure.

FIG. 6 is a diagram illustrating combination data of the image data and the GT data according to an embodiment of the present disclosure.

FIG. 7 is a diagram illustrating a data generation method according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

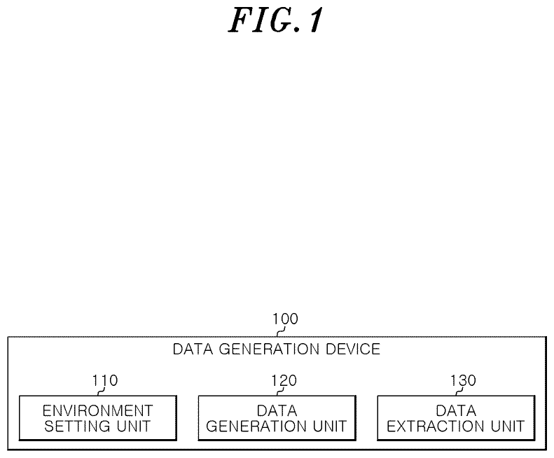

FIG. 1 is a diagram illustrating a data generation device according to an embodiment of the present disclosure.

Referring to FIG. 1, a data generation device 100 according to an embodiment of the present disclosure includes an environment setting unit 110, a data generation unit 120, and a data extraction unit 130. The data generation device 100 may be implemented as a computing device including a processor and memory. In one embodiment, the environment setting unit 110, the data generation unit 120, and the data extraction unit 130 may be implemented as software, stored in the memory, and performed by the processor.

The environment setting unit 110 may be configured to set a training environment for a neural network on the basis of a virtual map. For example, the environment setting unit 110 may set various environmental conditions such as a time condition and a weather condition on the virtual map. Here, the time condition may include daytime and nighttime. The weather condition may include clear, cloudy, rain, snow, and the like.

For example, when training data for night vehicle data is required, the environment setting unit 110 may set the time condition on the virtual map to night, generate a vehicle object, and set the vehicle object to an autonomous driving state. As another example, when the training data for vehicle data and pedestrian data in rainy weather is required, the environment setting unit 110 may set the weather condition to rain on the virtual map, generate a vehicle object and a pedestrian object, and then, set the vehicle object and the pedestrian object to an autonomous driving state.

Meanwhile, the environment setting unit 110 may be configured to set a sensing environment of at least one sensor within the virtual map. Here, the at least one sensor may be a virtual sensor implemented within the virtual map. As an example, the environment setting unit 110 may set a position suitable for generation or capturing of the training data on the virtual map and place the at least one sensor at the position. The environment setting unit 110 may determine a height and/or rotation angle of the sensor by adjusting a view at the position. Here, the at least one sensor may include a first sensor configured to acquire a color image, and a second sensor configured to acquire information on the at least one object. For example, the first sensor may be a red, green, blue (RGB) sensor, and the second sensor may be an instance segmentation sensor.

The data generation unit 120 may be configured to generate image data including at least one object using the at least one sensor on the virtual map. The image data generated by the data generation unit 120 may be used as input data for a neural network that requires training. The Neural network can be trained through a process of receiving the image data and classifying objects included in the image data.

The data extraction unit 130 may be configured to extract ground truth (GT) data for the image data generated by the data generation unit 120 on the virtual map. Here, the GT data may include bounding box information and mask information for the at least one object. The bounding box can be used to indicate the position of the object. The mask information may be used for classification of the object.

As an example, the data generation unit 120 may generate the image data for training of a neural network using the first sensor, and the data extraction unit 130 may extract a unique color value and/or contour information from at least one object within the virtual map using the second sensor. The data extraction unit 130 may detect the bounding box information and the mask information of each object on the basis of the color values and/or contour information of each object, and detect the object on the basis of this. In this case, the data extraction unit 130 may track a position of each object on the virtual map on the basis of a unique identifier for each object to generate the GT data for the image data. Thereafter, the data generation unit 120 may combine the image data, the bounding box information, and the mask information to generate the training data, and may generate a training dataset on the basis of a plurality of training pieces of data.

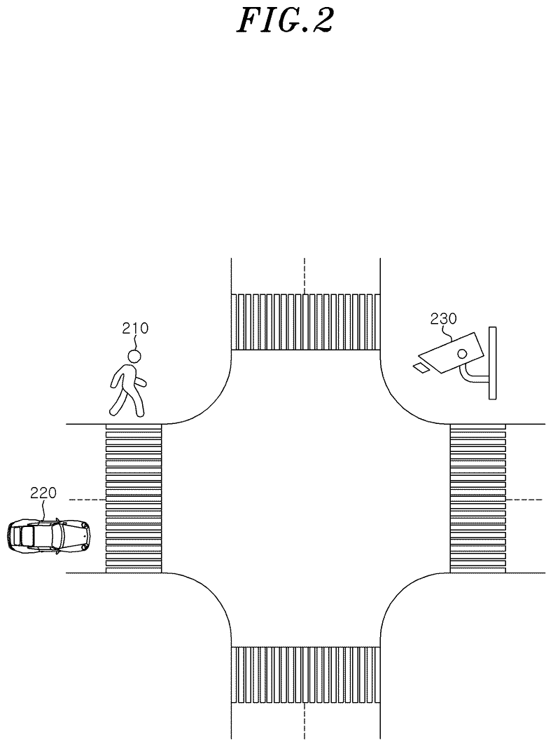

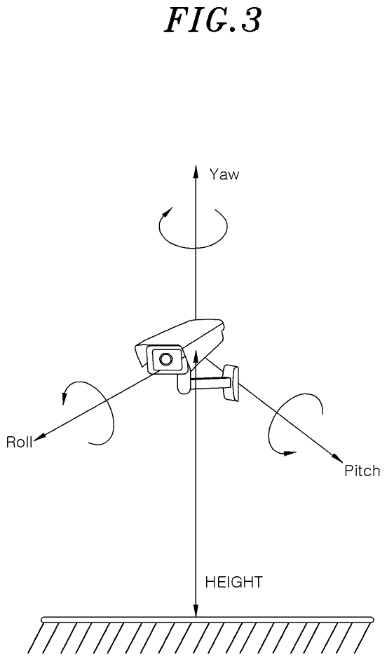

FIGS. 2 and 3 are diagrams illustrating a process in which the data generation device sets an environment for training of a neural network according to an embodiment of the present disclosure.

Hereinafter, as an example, a process of setting an environment for generating data for a traffic state at an intersection will be described with reference to FIGS. 2 and 3.

First, referring to FIG. 2, the data generation device may generate a three-dimensional virtual map including intersections and generate a pedestrian object 210 and a vehicle object 220 on the map. The data generation device may determine a position (coordinates) of a sensor 230 on the virtual map in order to acquire image data similar to an actual closed-circuit television (CCTV) image. In this case, the data generation device may set various environmental conditions such as a time condition, a weather condition, and a road condition depending on a training purpose. For example, the data generation device may set the weather condition to ‘cloudy’ or ‘clear’ so that environmental factors does not act on a road, and may set the time condition to ‘night’ so that a midnight light condition is reproduced. The data generation device may set the number of pedestrian object 210 and the number of vehicle objects 220 to minimize collision accidents and traffic jams.

Meanwhile, the data generation device may determine a height and rotation angle of the sensor 230 on the virtual map. Here, the rotation angle may include yaw, pitch, and roll. When the data generation device generates the training dataset, the data generation device may acquire image data at various viewpoints by adjusting the height and rotation angle of the sensor 230.

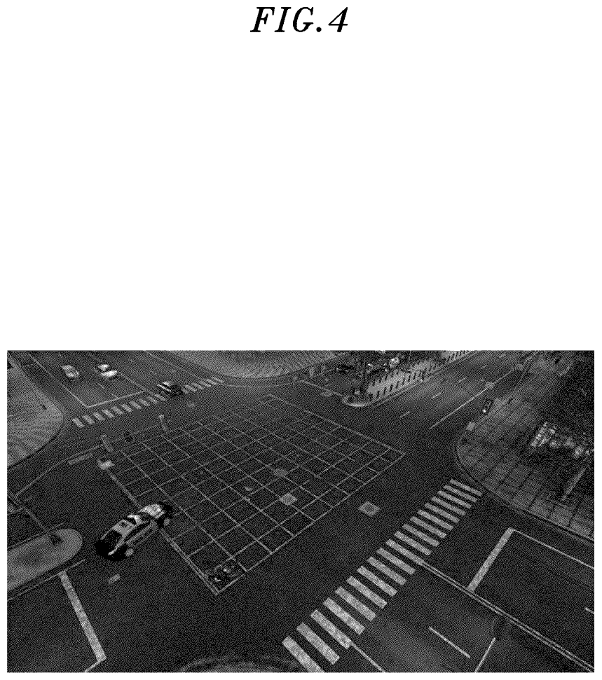

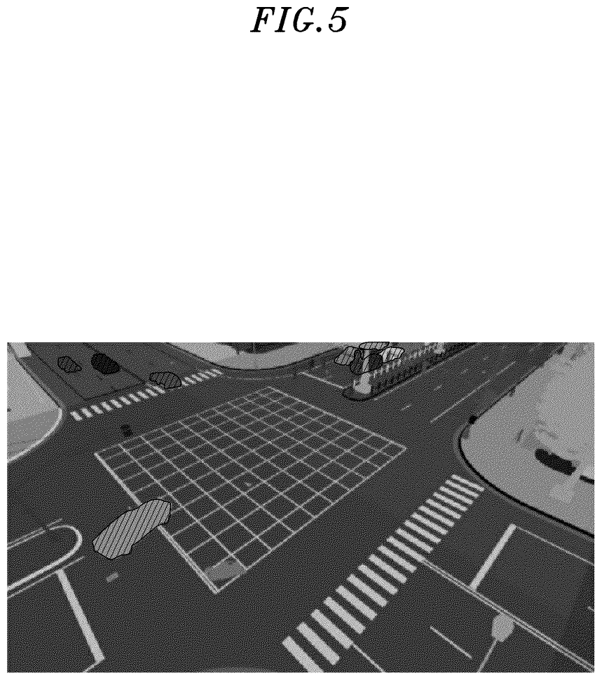

FIG. 4 is a diagram illustrating the image data according to an embodiment of the present disclosure, and FIG. 5 is a diagram illustrating the GT data according to an embodiment of the present disclosure.

Referring to FIGS. 4 and 5, as an example, the image data generated on the basis of an RGB sensor disposed on the virtual map by the data generation device is illustrated in FIG. 4, and GT data generated on the basis of an instance segmentation sensor disposed at the same position, height, and rotation angle as those of the RGB sensor is illustrated in FIG. 5. The image data and the GT data such as those illustrated in FIGS. 4 and 5 may be used for training of a nighttime road traffic situation in the Neural network.

Referring to FIG. 5, in the GT data, each vehicle object and each pedestrian object have a unique color value. The data generation device may extract the unique color value from each object, which may be used as the unique identifier for the object. The data generation device may track a position of each object on the basis of the unique identifier of the object.

The data generation device may acquire contour information indicating a shape and position (or disposition) of the vehicle object and/or the pedestrian object, in addition to the unique color value, on the basis of the instance segmentation sensor. Detection of an object in two dimensions means obtaining a bounding box for each object. After the data generation device acquires the contour information of the vehicle object and the pedestrian object from the instance segmentation sensor, the data generation device may calculate information on the bounding box (for example, x and y coordinates of an upper left vertex and x and y coordinates of a lower right vertex of the bounding box).

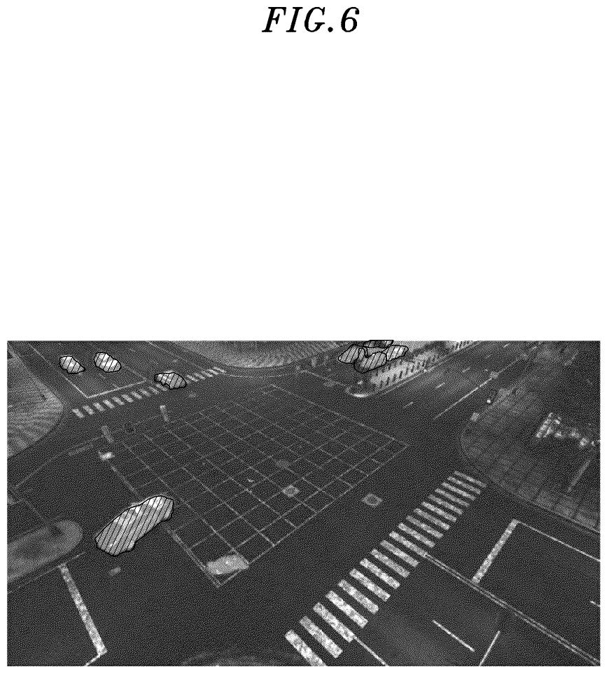

FIG. 6 is a diagram illustrating combination data of the image data and the GT data according to an embodiment of the present disclosure.

The data generation device according to an embodiment of the present disclosure may combine the mask for each object in the image data with the image data to generate the combination data as illustrated in FIG. 6. The combination data includes high-precision GT information and mimics data acquired in a real environment. Therefore, the combination data generated by the data generation device according to the embodiment of the present disclosure may be utilized as training data for a neural network or may be used to determine truth/false of hypotheses made up of formulas. Further, since the combination data has no restrictions when data that must be used in compliance with regulations or that is sensitive is used, and satisfies conditions that cannot be satisfied by actual data, the data generation device according to the embodiment of the present disclosure can greatly reduce a cost required for generation of the training data.

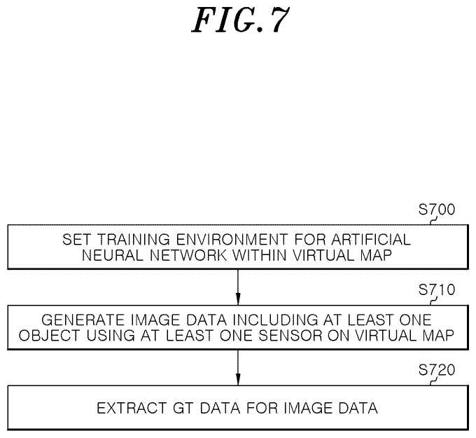

FIG. 7 is a diagram illustrating a data generation method according to an embodiment of the present disclosure.

Referring to FIG. 7, a training environment for a neural network may be set within the virtual map of the data generation device according to an embodiment of the present disclosure (S700). For example, the data generation device may set a time condition, a weather condition, and the like within the virtual map according to the environment in which the Neural network is to be trained. The data generation device may set a sensing environment of at least one sensor within the virtual map. As an example, the data generation device may set a position of the at least one sensor on the virtual map and determine a height and/or rotation angle of the sensor while adjusting a view at the position. Here, the at least one sensor may include an RGB sensor for acquiring a color image, and an instance segmentation sensor for acquiring information on the at least one object.

Thereafter, the data generation device may generate image data including at least one object using the at least one sensor on the virtual map (S710) and extract the GT data for the image data (S720). Here, the GT data may include the bounding box information and the mask information for the at least one object so that the Neural network predicts and/or classify a specific object. The GT data may include a label.

As an embodiment, the data generation device can generate image data (color images) for training of a neural network using the RGB sensor, and may extract the unique color value and/or contour information from objects included in the virtual map using the instance segmentation sensor. Further, the data generation device may detect the bounding box information and the mask information of each object on the basis of the unique color value and/or contour information of each object, and detect the object on the basis of the bounding box information and the mask information. The unique color value may be used as the unique identifier for the object, and the data generation device may track the position of the object on the virtual map on the basis of the unique identifier for each object. The data generation device may combine the image data with the GT data to generate the training data, and provide a training dataset generated through this process to the user.

Meanwhile, respective steps included in the data generation method performed by the data generation device according to the embodiment described above may be implemented as a computer program recorded on a recording medium, which includes instructions for causing a processor to perform the steps.

In addition, the respective steps included in the data generation method performed by the data generation device according to the embodiment described above is implemented in a computer-readable recording medium on which a computer program including instructions for causing the processor to perform the steps has been recorded.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An apparatus for generating data for training of a neural network, the apparatus comprising:
a memory configured to store one or more instructions; and
a processor configured to execute the one or more instructions stored in the memory, wherein the instructions, when executed by the processor, cause the processor to:
prepare 3D graphic road environment data required for rendering of 3D graphic road environment including a road and at least one object moving on the road, and set a photographing environment of a camera configured to capture the road and the at least one object moving on the road within the rendered 3D graphic road environment,
generate a virtual captured image obtained by capturing the road and the at least one object moving on the road in the 3D graphic road environment based on information on the photographing environment of the camera, and
extract training ground truth (GT) data from the virtual captured image to generate the data for training of the Neural network including the virtual captured image and the training GT data.

2. The apparatus of claim 1, wherein the processor is configured to set a time condition and a weather condition corresponding to daytime or nighttime in the 3D graphic road environment.

3. The apparatus of claim 1, wherein the photographing environment includes an installation position, height, and rotation angle of the camera within the 3D graphic road environment.

4. The apparatus of claim 1, further comprising:
an object detector installed to the inside or outside of the camera and configured to acquire information on the at least one object.

5. The apparatus of claim 4, wherein the processor is configured to extract a unique color value and contour information from the at least one object using the object detector.

6. The apparatus of claim 1, wherein the training GT data includes bounding box information indicating an area in which there is the at least one object and mask information indicating an identifier for identifying the at least one object.

7. The apparatus of claim 1, wherein the photographing environment of the camera includes a photographing environment for each of cameras installed at a plurality of positions, and
wherein the processor is configured to generate a plurality of virtual captured images based on information on the photographing environment of each of the cameras installed at the plurality of positions, and assign a unique identifier for the at least one object and tracks a position of the at least one object detected from the plurality of virtual captured images based on the unique identifier to generate the training GT data.

8. A training data generation method to be performed by an apparatus for generating training data, the training data generation method comprising:
preparing 3D graphic road environment data required for rendering of 3D graphic road environment including a road and at least one object moving on the road;
setting a photographing environment of a camera configured to capture the road and the at least one object moving on the road within the rendered 3D graphic road environment;
generating a virtual captured image obtained by capturing the road and the at least one object moving on the road in the 3D graphic road environment based on information on the photographing environment of the camera;
extracting training ground truth (GT) data from the virtual captured image; and
generating the training data including the virtual captured image and the training GT data.

9. The training data generation method of claim 8, wherein the setting the photographing environment of the camera includes setting a time condition and a weather condition corresponding to daytime or nighttime in the 3D graphic road environment.

10. The training data generation method of claim 8, wherein the setting the photographing environment of the camera includes setting an installation position, height, and rotation angle of the camera within the 3D graphic road environment.

11. The training data generation method of claim 8, further comprising:
acquiring information on the at least one object using an object detector installed to the inside or outside of the camera.

12. The training data generation method of claim 11, wherein the generating the virtual captured image further includes extracting a unique color value and contour information from the at least one object using the object detector.

13. The training data generation method of claim 8, wherein the training GT data includes bounding box information indicating an area in which there is the at least one object and mask information indicating an identifier for identifying the at least one object.

14. The training data generation method of claim 8, wherein the photographing environment of the camera includes a photographing environment for each of cameras installed at a plurality of positions, and
wherein the generating the virtual captured image includes generating a plurality of virtual captured images based on information on the photographing environment of each of the cameras installed at the plurality of positions.

15. The training data generation method of claim 14, wherein the extracting the training GT data includes assigning a unique identifier for the at least one object, and tracking a position of the at least one object detected from the plurality of virtual captured images based on the unique identifier.

16. A non-transitory computer readable storage medium storing computer executable instructions, wherein the instructions, when executed by a processor, cause the processor to perform a training data generation method, the method comprising:
preparing 3D graphic road environment data required for rendering of 3D graphic road environment including a road and at least one object moving on the road:
setting a photographing environment of a camera configured to capture the road and the at least one object moving on the road within the rendered 3D graphic road environment:
generating a virtual captured image obtained by capturing the road and the at least one object moving on the road in the 3D graphic road environment based on information on the photographing environment of the camera;
extracting training ground truth (GT) data from the virtual captured image; and
generating training data including the virtual captured image and the training GT data.

17. The non-transitory computer readable storage medium of claim 16, wherein the setting the photographing environment of the camera includes setting a time condition and a weather condition corresponding to daytime or nighttime in the 3D graphic road environment.

18. The non-transitory computer readable storage medium of claim 16, wherein the setting the photographing environment of the camera includes setting an installation position, height, and rotation angle of the camera within the 3D graphic road environment.

19. The non-transitory computer readable storage medium of claim 16, wherein the training GT data includes bounding box information indicating an area in which there is the at least one object and mask information indicating an identifier for identifying the at least one object.

20. The non-transitory computer readable storage medium of claim 8, wherein the photographing environment of the camera includes a photographing environment for each of cameras installed at a plurality of positions, and
wherein the generating the virtual captured image includes generating a plurality of virtual captured images based on information on the photographing environment of each of the cameras installed at the plurality of positions.
